(19) United States
(12) Patent Application Publication
(10) Pub. No.: US 2025/0107503 A1
(43) Pub. Date: Apr. 3, 2025

(54) SOUNDPROOF DOG KENNEL

(71) Applicant: Stefan J. Feuerstein, Chicago, IL (US)

(72) Inventor: Stefan J. Feuerstein, Chicago, IL (US)

(21) Appl. No.: 18/915,511

(22) Filed: Oct. 15, 2024

Related U.S. Application Data
(63) Continuation-in-part of application No. 18/478,662, filed on Sep. 29, 2023, now Pat. No. 12,144,319.

(51) Int. Cl. A01K 1/03; A01K 1/00; A01K 1/035; A01K 29/00

(52) U.S. Cl. CPC A01K 1/034; A01K 1/0064; A01K 29/00; A01K 1/0353

(57) ABSTRACT

A soundproof dog kennel includes a housing with noise-dampening walls and a noise-dampening door for dog ingress/egress. One or more walls has a ventilation assembly with noise-dampening baffles that permits inflow of breathable air with dampened sound waves when the door is closed, featuring hollow corridors, an air intake end, and an exhaust end. Fans force air through the sound-dampening ventilation ducts to reduce ambient noise while removing stale air. The kennel is equipped with cameras, carbon dioxide sensors, and other safety and monitoring devices. A smartphone application enables remote monitoring through live camera feeds, real-time sensor data display, and remote control of kennel functions. The system can automatically open the door if air quality or temperature reaches predetermined thresholds. This kennel protects dogs from noise pollution sources like fireworks, engines, and airplane auxiliary power units, providing a safe, quiet, and remotely monitored space for dogs.

### OTHER RELATED APPLICATIONS

The present application is a continuation-in-part patent application of allowed and pending U.S. patent application Ser. No. 18/478,662, filed on Sep. 29, 2023, which is hereby incorporated by reference.

### BACKGROUND OF THE INVENTION

### 1. Field of the Invention

The present invention relates to advanced pet accommodation systems and, more specifically, to an innovative dog kennel incorporating state-of-the-art noise-dampening technologies. This kennel is designed to create a serene and stress-free environment for canines, effectively mitigating the impact of external auditory disturbances.

### 2. Description of the Related Art

Traditional dog kennels, while providing basic shelter, often fall short in addressing the critical issue of noise pollution and its detrimental effects on canine well-being. Various attempts have been made to incorporate soundproofing materials into pet enclosures; however, these solutions typically offer limited effectiveness and fail to provide a comprehensive approach to noise reduction. The current state of the art lacks an integrated system that combines active noise cancellation, smart ventilation, and remote monitoring capabilities to create a truly peaceful sanctuary for dogs.

Applicant believes that a related reference corresponds to U.S. Pat. No. 8,276,544 to Seltzer, which discloses a sound dampened pet abode. The cited disclosure comprises a pet abode with sound dampening characteristics comprising an interior space of a pet abode having sufficient dimensions to allow a pet to comfortably reside within the interior space. The interior space is formed from at least three walls, where one or more of the walls exhibits sound damping characteristics. The sound damping characteristics are from one or more sounds originating from a source external to the interior space. That is, the interior space of the pet abode is soundproofed, allowing a pet to be undisturbed by loud noises outside the interior space. In column 2, lines 10-24, Seltzer discloses a closeable door and a cooling system, including an exterior intake and outtake opening within the material of the pet abode, wherein the cooling system has at least one fan. In column 4, lines 5-10, Seltzer teaches the door can create a soundproof (or Sound minimizing) seal when closed, allowing abode to remain sound dampened while having multiple entry/exit points. Therefore, when the abode is closed, Seltzer uses the cooling system to maintain pleasant conditions within the abode. Seltzer does not teach or suggest a solution to reduce noise coming into the abode through the cooling system and does not incorporate ventilation ducts specifically designed to treat and dissipate sound carried by air entering the pet abode when the door is closed, thus allowing for sound-dampened, breathable air to enter the pet abode while the door is sealed and carrying out its function of restricting sound from bothering the animal housed in the abode.

Applicant believes that another related reference corresponds to U.S. Pat. No. 10,791,701 which discloses a collapsible sound reducing pet container. The cited disclosure comprises a collapsible sound reducing pet container when fully assembled forms an enclosure having a generally rectangular volume with manually disassemblable top, bottom, front, rear, left and right panels. The front panel defines a cutout having an area less than that of the front panel, and at least one of the panels comprises multiple layers of dissimilar soundproofing material. An electric fan mounted to one of the panels, becomes energized in response to the presence of an animal within the enclosure. Each of the top, front, rear, left, and right panels is sized to allow all of the panels to be stacked between and enclosed within the top and bottom panels, to collapse the container for transport and storage.

U.S. Pat. No. 10,208,975 B2 to Azevedo teaches a pet crate that adjusts the environment inside the pet crate automatically in response to an animal or a condition and provides a human a means for monitoring the animal, interacting with the animal, and/or controlling the animal's environment. Moreover, Azevedo discloses that the interior environment of the pet crate may be conditioned actively or passively. Passive environmental conditioning adjusts the environment within the pet crate by passively changing some aspects of the environment. For example, passive environmental conditioning may include insulating the walls of the pet crate to attenuate sound (i.e., soundproofing). The sound insulation may be embodied by applying noise-absorbing material (e.g., open-cell foams, fiberglass, mineral fiber board, etc.) within the walls of the pet crate or to the interior/exterior surfaces of the walls (e.g., sound baffles). The Azevedo patent lacks soundproofing in the door and does not include a mechanism to block sound from entering through it. Additionally, there are no ventilation ducts designed to address the sound carried by the incoming air. As a result, air flows freely into the pet abode without sound treatment. In contrast, this invention offers a significant improvement: it provides sound protection on all walls, including the door, and incorporates ventilation ducts specifically designed to treat and dissipate sound carried by air entering the pet abode when the door is closed, thus allowing for sound-dampened, breathable air to enter the pet abode while the door is sealed and carrying out its function of restricting sound from bothering the animal housed in the abode.

Other documents describing the closest subject matter provide for a number of more or less complicated features that fail to solve the problem in an efficient and economical way. The cited references fail to address a noise-dampening or noise-canceling dog kennel comprising a box-shaped housing consisting of a series of walls and a closeable door to permit egress and ingress of a dog, wherein one or more of the walls has an incorporated ventilation system with noise dampening characteristics comprising at least one hollow corridor, an air intake end, and an exhaust end wherein a fan is located at the air intake end and is operable to force air through the at least one hollow corridor, thereby dampening and/or canceling ambient noise while providing fresh air to the animal in the abode.

### SUMMARY OF THE INVENTION

One of the objectives of the present invention is to provide a dog kennel designed to protect animals from loud noises, particularly fireworks, airplane engines, airplane auxiliary power unit systems (APU), generators, and other sources of noise pollution that can potentially cause distress or harm to animals.

It is another object of this invention to provide a dog kennel having ventilation passages disposed on one or more of its walls that allow air to flow through while simultaneously dissipating noise.

It is still another object of the present invention to provide a safe place to keep dogs that reduces sound that pets are exposed to and thus reduces anxiety.

It is still another object of the present invention to provide a safe place to keep dogs that allows their barking not to be heard from the outside, say, during nighttime hours or times when silence is required.

It is a further object of the present invention to provide a versatile and adaptable noise-dampening dog kennel that is suitable for various applications, with a primary focus on home use. The kennel's features, including its soundproofing capabilities, ventilation system, and remote monitoring functionality, make it an ideal solution for pet owners in diverse living situations. It should be noted that the kennel's adaptability extends beyond home use, making it suitable for veterinary clinics, boarding facilities, and even travel scenarios, thus offering a comprehensive solution for canine comfort and well-being across various settings.

It is yet another object of this invention to provide such a device that is inexpensive to implement and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a partially broken operational view of the present invention.

FIG. 2 shows a cross-sectional top view of the baffle box assembly 40 from lines B-B in one exemplary embodiment thereof.

FIG. 3 illustrates a cross-sectional view of the of the present invention from lines A-A

FIG. 4 is a representation of a schematic diagram of the present invention according to an exemplary embodiment.

FIG. 5 depicts an isometric view of the present invention in an alternate embodiment.

FIG. 6 showcases an isometric view of the illustrative embodiment 100 of the present invention.

FIG. 7 illustrates a diagram representation of the present invention according to an exemplary embodiment.

### DETAILED DESCRIPTION OF THE EMBODIMENTS OF THE INVENTION

Referring now to the drawings, where the main embodiment of the present invention is generally referred to with numeral 10, it can be observed that it basically includes a kennel assembly 20, at least one ventilation assembly with noise-dampening baffles 40 and an electronic assembly 60. An alternative embodiment of the present invention is referred to with numeral 100. It should be understood there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

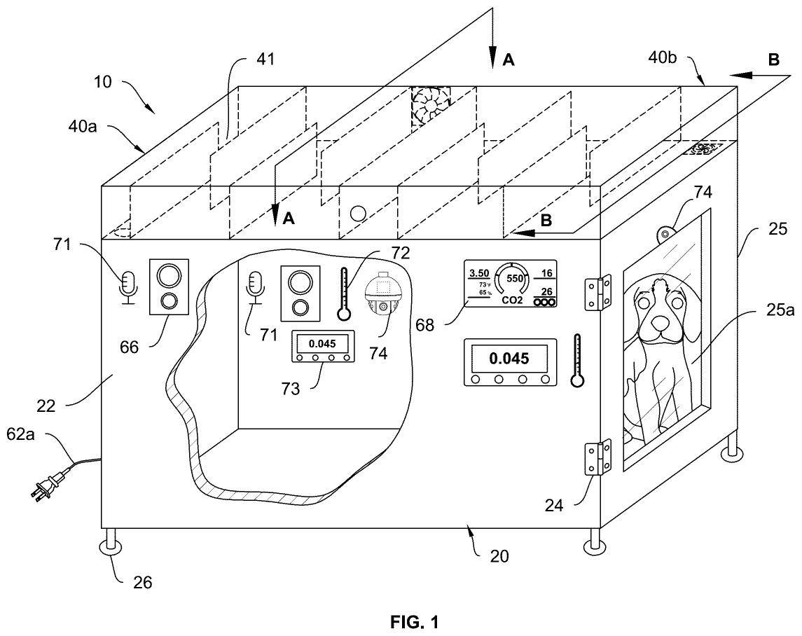

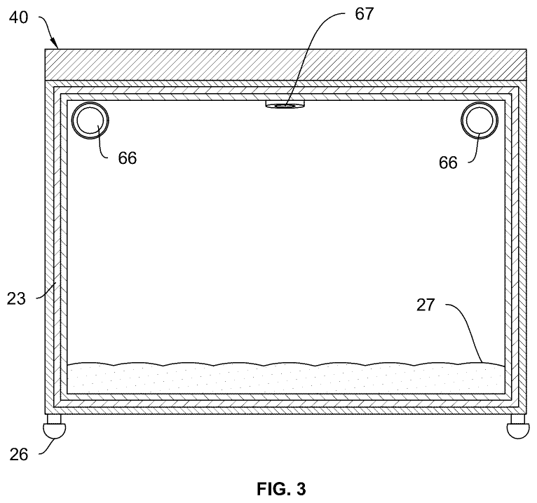

As illustrated in FIG. 1-3 the present invention 10 includes kennel assembly 20 (also termed as kennel 20). The kennel assembly 20 may be a structure designed primarily to provide shelter, confinement (stationary or during transportation, depending on operational conditions), and security for dogs. Furthermore, the kennel 20 can be pre-assembled or assembled by the user. In various embodiments, the kennel assembly 20 may consist of four walls, a base, and a roof, forming an enclosed space that serves as a containment area for dogs. Kennels, as known in the prior art, are commonly constructed using materials such as wood, metal, or chain link fencing, with dimensions that vary based on the intended use and the number or size of dogs it is meant to accommodate. The shape of the kennel assembly can be rectangular or square, with variations in size and design to suit different needs. It should be understood that the kennel assembly 20 as shown in the figures, is presented for illustrative purposes and not in a limiting sense. Thus, the general structure thereof may vary without departing from the scope of the appended claims. In an exemplary embodiment, the kennel assembly may include walls 22 composed of layers 23, hinges 24 connected to one of the walls 22 and to a door 25, legs 26 and inner cushioning 27. It should be understood that the aforementioned components may serve as the foundation for the present invention and are not meant to be limiting in any way. Additional components may be added based on operational conditions. The walls 22 may enclose and define the space, providing containment and separation for dogs within the designated area. Depending on the general geometry of the present invention 10, the kennel may be composed of four, or more, lateral walls 22, a roof and a base. For explanatory purposes, the kennel herein disclosed may include four lateral walls 22. Wherein said walls 22 may form a cuboid structure. In different embodiments, each of the walls 22 may have a quadrangular, a rectangular, a regular and/or an irregular shape. Each of the walls 22 may be constructed with suitable materials as known in the prior art for noise cancelation, which may be engineered to minimize the propagation of sound waves, thereby creating a space that may be less affected by external noise disturbances. The walls 22 may be constructed with multiple layers 23 of different materials to mitigate and cancel noise, as shown in FIG. 3 for illustrative purposes. Such layered materials may serve to absorb, deflect, or dampen sound waves. In one embodiment, acoustic insulation materials such as fiberglass or foam panels, which absorb sound energy, may be used for the layers 23. Additionally, thick and dense materials like mass-loaded vinyl may help to block sound from passing through. The arrangement of suitable materials, such as the ones listed, in layers 23 may create a barrier that disrupts the path of sound waves. Legs 26 may be disposed at the corners of the base of the kennel, or in other suitable arrangement. The legs 26 may be constructed, in full or in part, of acoustic insulation materials to prevent sound transmission, or placed on sound dampening coasters. When sound travels through the floor, it can disrupt the kennel's primary purpose of noise reduction. By using acoustic insulation materials for the legs 26, a sound-resistant barrier is established, effectively insulating the kennel from the floor. This separation ensures that sound vibrations are not easily transmitted through the legs. Materials commonly found in drum set legs, for instance, can also be utilized in the kennel legs 26 to further hinder the transmission of sound. The door 25 may be removably attached to a wall by means of hinges 24. In a suitable embodiment, the hinges 24 may be demountable, allowing a user to easily attach or detach the door 25 from the kennel 20. This versatility enables several configurations: in one, door 25 can be disengaged while part of the hinges 24 remains attached to kennel 20; in another, the hinges 24 themselves can be fully removed from kennel 20 while staying connected to door 25; and in yet another, the hinges 24 remain fixed to kennel 20, allowing door 25 to be attached or detached directly from the hinges. It must be understood that any other suitable fastening means may be used to replace the hinges 24. Additionally, the door 25 may be created with sound canceling materials as the ones used to manufacture the walls 22. In various embodiments, the door 25 may include additional features, such as a window 25a that may allow the user to visually monitor the state of the dog inside the kennel 20. The window 25a may be double/triple glazed. In alternative embodiments, the window 25a could be constructed from any suitable transparent and sound-insulating materials. In another exemplary embodiment, the door 25 may be a sliding door. In an alternate embodiment, even when the door 25 is removed, the kennel 20 can still function as a shelter, sleeping area, or bed for dogs or other animals, though its soundproofing capability is diminished. The door 25 may include an electric door latch 69. The electric door latch 69, can be automatically activated when sensors within the electronic assembly 60 detect specific conditions that could pose a danger to the animal. For example, this activation occurs in response to detecting elevated levels of carbon dioxide, insufficient oxygen, or temperatures exceeding or falling below predefined thresholds. When door 25 is closed, there is an urgent need for a ventilation system that not only provides airflow but also reduces the noise transmitted through the air into the kennel. This is where a ventilation system with noise-dampening characteristics, such as integrated baffles, becomes essential, as described below.

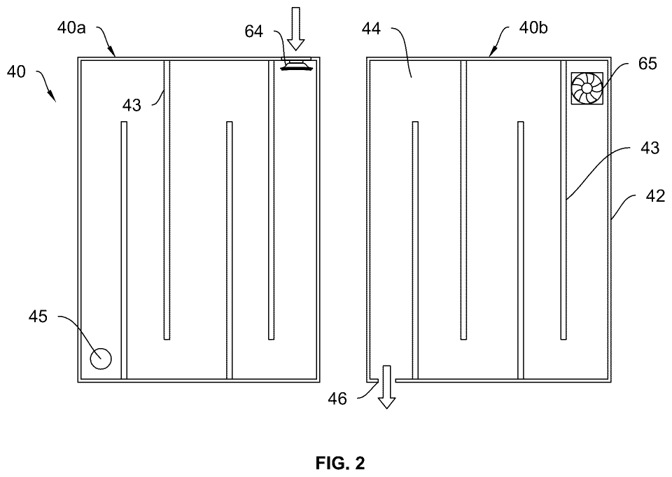

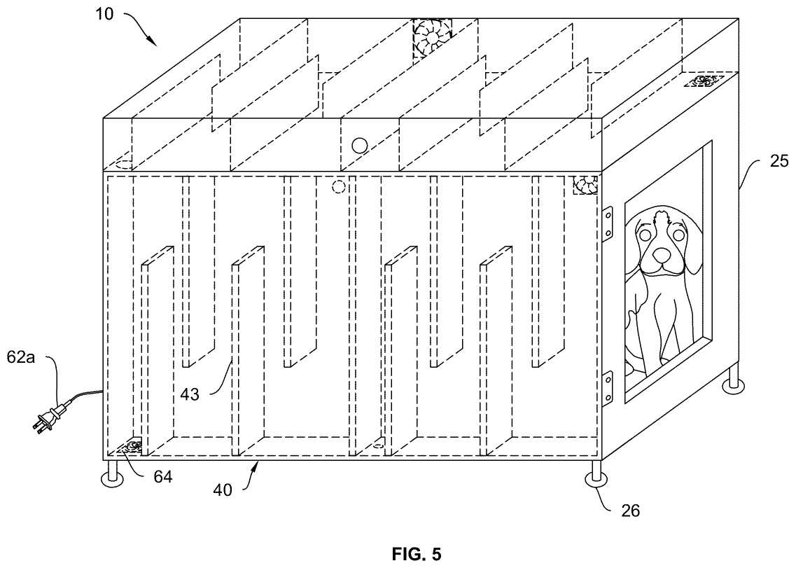

As appreciated in FIG. 1-2 the ventilation assembly with noise-dampening baffles 40 formed by an inlet section 40a and an exhaust section 40b. Each section may include a housing 42, baffles 43, and a base 44. The inlet portion 40a may include an air intake 45 and may work in concert with a fan 64 from the electronic assembly 60. The exhaust section 40b, on the other hand, may include a vent 46 (also termed as exhaust end) and may work together with an extractor 65 from the electronic assembly 60. A baffle, may be a structural or acoustic component designed to alter the direction, flow, or properties of a fluid or sound. In the context of acoustic baffles, they are typically used to control or modify the propagation of sound waves. The ventilation assembly with noise-dampening baffles 40 may be constructed of acoustic insulation materials to prevent sound transmission while still allowing the inflow of breathable air when the kennel door is closed. In a suitable embodiment, the ventilation assembly with noise-dampening baffles 40 may be disposed on the kennel's roof as depicted in FIG. 1. Nonetheless, in other embodiments, the ventilation assembly with noise-dampening baffles 40 may be embedded in any of the walls 22 that comprises the kennel 20. See for instance FIG. 5, in which multiple inlet sections and exhaust sections are disposed in varying locations. Furthermore, in FIG. 1 the inlet section 40a is adjacent to the exhaust section 40b, however, such a configuration is shown for illustrative purposes, as both the inlet section and the exhaust sections (40a, 40b) may be embedded in different walls 22 or portions of the kennel 20. The housing 42 may refer to the lateral enclosure that surrounds the baffles 43 of each section, whereas the base 44 may be the surface that supports the baffles 43. The baffles 43 may be positioned to disrupt the path of sound waves. The baffles 43 may be arranged in a manner that creates a labyrinth-like structure creating channels or passages through which air must navigate. As sound waves navigate through the channels created by the baffles 43, they are dampened, causing the sound wave amplitude to diminish by the time they reach the final end of the channel. The baffles 43 within each of the inlet section 40a and the exhaust section 40b may form at least one hollow corridor 41. In the kennel's exhaust section (40b), the extractor 65 may remove air from the kennel's interior. The air follows a path through the baffles 43 until it ultimately reaches the vent 46. Concurrently, within the air injection side (inlet section 40a), the fan 64 may be strategically mounted on the housing 42 to introduce fresh air into the channels. In general, air vents, fan 64 and extractor 65 may be placed to allow maximum airflow and the least obstruction depending on the location where the kennel may be placed. However, it's important to note that due to the configuration of the baffles, air could still circulate throughout the space even if only one fan 64 or extractor 65 is installed. This synchronized process is essential, allowing for the circulation of air through the kennel 20. It ensures the removal of stale air and the continuous supply of noise-free, clean air into the kennel through the air intake 45. The harmonious operation of the inlet and exhaust sections (40a, 40b) is pivotal in maintaining a comfortable environment for the animals inside.

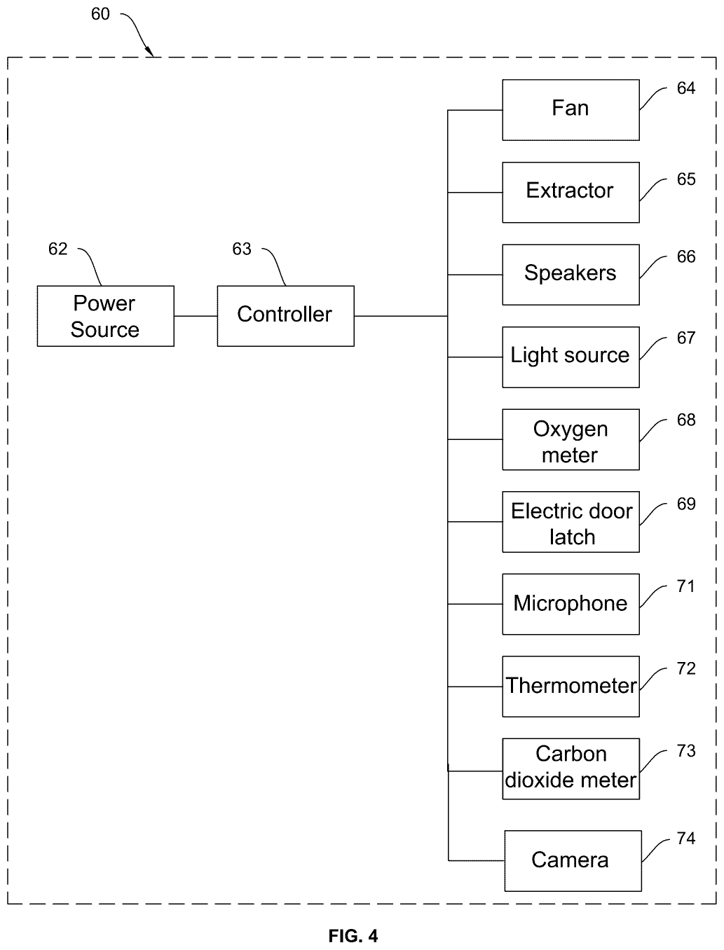

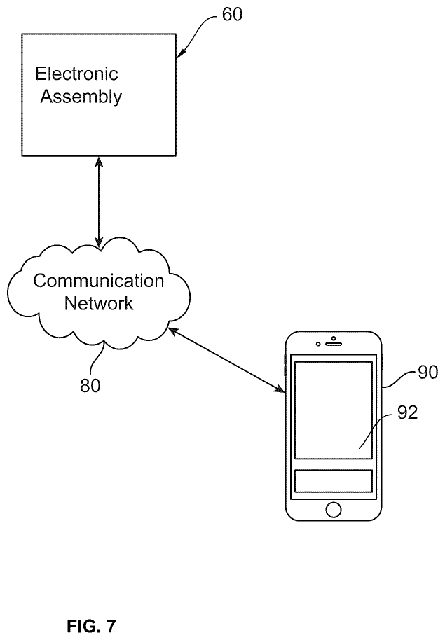

The electronic assembly 60 may include a power source 62, a controller 63, the fan 64, the extractor 65, speakers 66, a light source 67, gas sensors (such as an oxygen meter 68 and a carbon dioxide meter 73), the electric door latch 69, a microphone 71, and a thermometer 72. As depicted in the schematic diagram of FIG. 4, the power source 62 may be electrically connected to the rest of the components to provide power supply to them. The power source 62 may be, for instance, a battery or the like. Alternatively, the present invention may include a power cord 62a that can be plugged into a standard electrical outlet or power source. Said controller 63 may govern the operation of the remaining components; wherein the controller 63 may be a built-in control panel or remote control systems that may enable the user to adjust and manage the electronic components. The controller 63 may include setting the desired temperature, adjusting lighting levels, configuring ventilation settings, or the like. The electronic assembly 60 may be mounted inside and/or outside the kennel assembly 20 and/or to the baffle box assembly 40. In a suitable embodiment, the extractor 65 may remove stale air, odors, and potentially harmful substances from the kennel environment. It may maintain good air quality, regulate temperature and humidity. The light source 67 may be disposed within the kennel 20. Additionally, the speakers 66 may be internally (facing the interior of the kennel 20) and/or externally mounted on the walls 22 to reproduce predetermined sounds such as white noise, music, or the like, that may help reduce noise perception coming from the environment. The user, by means of the controller 63, may select the sound to be reproduced. The speakers 60 may also enable the animal inside the kennel to hear surrounding sounds by capturing external sounds and transmitting them to the interior speakers. This configuration is achieved through the combination of microphone 71 characteristics, controller 63 functions, and speakers 66 operations: microphones 71 acquire sound waves and convert them into an electrical signal, which is received by controller 63. The controller 63 may possess filtering capabilities to eliminate frequencies outside a predetermined range, such as frequencies emitted by fireworks. The filtered signal is then transmitted for reproduction by the speakers 66. In another embodiment, the microphone 71 may be disposed within the kennel and the speakers 66 on the outside to enable individuals near the kennel to listen to the animal inside and to hear any distress, barking, or other sounds occurring within. The oxygen meter 68 may measure oxygen levels inside the kennel when the door is closed, when levels below a predetermined threshold are detected, the oxygen meter 68 may send a signal to the controller 63 for the latter to actuate the electric door latch 69, thereby unlocking the door 25. The same principle may be applied to what may be sensed by the thermometer 71 and carbon dioxide meter 73. The electronic assembly may further include a camera 74 that may be located inside the kennel as well as outside the kennel. As depicted in FIG. 7, the electronic assembly 60 may be connected to a smartphone 90 by means of a communication network 80. Wherein the smartphone 90 may include an application software to control the electronic assembly 60.

The communication network 80 may be embodied as a wireless network such as Wi-Fi, Bluetooth, or cellular data (3G, 4G, 5G, etc.). This network enables bidirectional communication between the smartphone 90 and the kennel's electronic assembly 60. The smartphone 90 runs an application software specifically designed for controlling the kennel. This app would serve as the user interface for remotely managing all aspects of the kennel's electronic assembly 60. For instance, users may be able to adjust fan and extractor speeds, monitor and control temperature, view real-time gas sensor readings, manage lighting, and control the audio system. The app 92 may allow for remote operation of the electric door latch, viewing of live camera feeds, and monitoring of power levels. In one alternative embodiment, the app 92 may also enable users to run system diagnostics, set up emergency protocols, and manage multiple kennels if applicable. In yet another suitable embodiment, the app may offer data logging and analysis capabilities, allowing pet owners to track environmental conditions over time and generate usage reports.

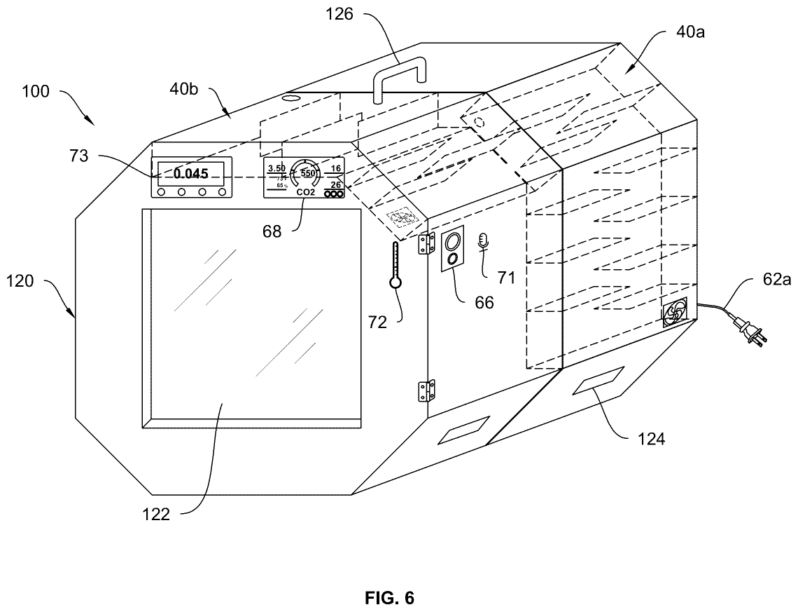

FIG. 6 showcases an alternative embodiment 100 of the present invention. In the present embodiment, the kennel 120 may include a window 122 on the door, carrying means such as holes 124 for the transportation with forklifts and/or handles 126. The kennel 120 in the present embodiment may be used as an airplane transportation pod for dogs and/or other pets. In airplanes, pets are kept in the cargo hold near equipment like generators and the Auxiliary Power Unit (APU) that generate significant noise. Pets are also kept together, exposed to barking that causes more stress. This adds to noise from airplane engines, which can be scary for animals like dogs. In the present embodiment, the kennel 120 may conform with airplane freight size and shape requirements. Both the inlet section 40a and the exhaust section 40b of the baffle box assembly 40, as described above, may be incorporated into the current embodiment as depicted in FIG. 6. The elements of the electronic assembly 60 may also be used to inject and extract air from the interior of the kennel 120 and for monitoring the state of the animal inside the kennel 120. Therefore, it should be understood that the alternative embodiment 100 may also include the power source 62, the controller 63, the fan 64, the extractor 65, speakers 66, the light source 67, gas sensors (such as the oxygen meter 68 and the carbon dioxide meter 73), the electric door latch 69, the microphone 71, and the thermometer 72. In the present embodiment, it can be appreciated that the exhaust section 40b may be disposed within a top portion of the kennel 120, whereas the inlet portion 40a may be disposed within a lateral wall thereof. Such a configuration is intended to demonstrate how the portions (40a, 40b) may be disposed in separate walls within the kennel 120 and still achieve their main functionality, that is: allowing for the circulation of air through the kennel 120 while reducing environmental noise. In different embodiments, the window 122 may be double/triple glazed. The holes 124 may be forklifting holes, also known as forklift pockets or forklift slots, which are openings or channels designed into the bottom portion of the kennel 120 to facilitate lifting and transportation using a forklift. These holes 124 or slots are strategically positioned to allow the forklift's forks to be inserted, providing a secure grip for lifting and moving the object. The kennel 120 may include one or multiple handles 126 which may provide a convenient and secure grip for lifting, carrying and maneuvering the kennel 120.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A noise-dampening dog kennel, comprising:
a) a box-shaped housing having a plurality of noise-dampening walls defining an enclosed interior space; wherein said box-shaped housing includes a noise-dampening door on a front face thereof configured to permit ingress and egress of an animal, wherein said noise-dampening door is closeable;
b) a ventilation assembly with noise-dampening baffles integrated within at least one wall of the plurality of walls, the ventilation assembly with noise-dampening baffles comprising:
i. at least one hollow air corridor having an air intake end and an air exhaust end;
ii. a fan positioned at the air intake end configured to force air through the at least one hollow air corridor; and
iii. a plurality of baffles mounted on a planar base, said plurality of baffles are arranged in an alternating pattern defining a switchback-shaped continuous channel for air to travel through;
iv. wherein said ventilation assembly with noise-dampening baffles permits inflow of breathable air while dampening sound waves carried by the air when the door is closed;
c) wherein the airflow through the baffle box assembly reduces ambient noise within the enclosed interior space.

2. The noise-dampening dog kennel of claim 1, further comprising an extractor positioned at the air exhaust end of the at least one hollow air corridor, the extractor configured to remove air from the enclosed interior space.

3. The noise-dampening dog kennel of claim 1, wherein the plurality of noise-dampening walls and the noise-dampening door comprise multiple layers of sound-dampening materials.

4. The noise-dampening dog kennel of claim 1, further comprising an electronic assembly, the electronic assembly comprising: a power source; a controller; the fan; an extractor; one or more speakers; a light source; one or more gas sensors; a thermometer; and an electric door latch.

5. The noise-dampening dog kennel of claim 4, wherein the controller is configured to activate the electric door latch in response to gas, temperature, or oxygen levels exceeding or falling below predefined thresholds.

6. The noise-dampening dog kennel of claim 5, wherein the light source is disposed within the enclosed interior space, and wherein the one or more speakers are disposed within the enclosed interior space or on an outer surface of the noise-dampening dog kennel.

7. A noise-dampening dog kennel, comprising:
a) a box-shaped housing having a plurality of noise-dampening walls defining an enclosed interior space; wherein said box-shaped housing includes a noise-dampening door on a front face thereof configured to permit ingress and egress of an animal, wherein said noise-dampening door is closeable;
b) a ventilation assembly with noise-dampening baffles integrated within at least one wall of the plurality of walls, the ventilation assembly with noise-dampening baffles comprising:
i. a housing enclosing a plurality of baffles;
ii. a base supporting the plurality of baffles, said plurality of baffles arranged in an alternating pattern to define a switchback-shaped continuous channel for air to travel through, wherein each baffle extends partially across the width of the base;
iii. an inlet portion comprising: a fan mounted at a distal end of a first hollow corridor; an air intake located at an opposite distal end of the first hollow corridor, the air intake connecting the first hollow corridor with the enclosed interior space;
iv. an outlet portion comprising: an extractor mounted at a distal end of a second hollow corridor; a vent located at an opposite distal end of the second hollow corridor;
v. wherein said ventilation assembly with noise-dampening baffles permits inflow of breathable air while dampening sound waves carried by the air when the door is closed;
c) an electronic assembly comprising: a power source; a controller; one or more speakers; a light source disposed within the enclosed interior space; one or more gas sensors; a thermometer; and an electric door latch; and
d) wherein the plurality of baffles are arranged to disrupt sound waves as they travel through the first and second hollow corridors.

8. The noise-dampening dog kennel of claim 7, wherein the plurality of noise-dampening walls and said noise-dampening door comprise multiple layers of sound-dampening materials.

9. The noise-dampening dog kennel of claim 7, wherein the one or more gas sensors comprise an oxygen meter and a carbon dioxide meter.

10. The noise-dampening dog kennel of claim 7, further comprising legs disposed on a base of the box-shaped housing, wherein the legs comprise acoustic insulating materials.

11. The noise-dampening dog kennel of claim 7, wherein said noise-dampening door is removably or permanently attached to the box-shaped housing by means of hinges.

12. The noise-dampening dog kennel of claim 7, wherein the one or more speakers are configured to play predetermined sounds or filtered environmental sounds transmitted from a microphone positioned externally to the enclosed interior space.

13. The noise-dampening dog kennel of claim 12, wherein an additional microphone is placed inside the kennel and is connected to speakers placed on the exterior surface of the kennel, allowing sounds from inside the kennel to be heard outside while maintaining the kennel's noise-dampening function.

14. The noise-dampening dog kennel of claim 7, wherein the controller is configured to activate the electric door latch in response to gas, temperature, or oxygen levels exceeding or falling below predefined thresholds.

15. The noise-dampening dog kennel of claim 7, wherein the inlet portion and the outlet portion of the baffle box assembly are located on different walls of the plurality of noise-dampening walls.

16. The noise-dampening dog kennel of claim 7, further comprising:
a) a smartphone device running an application software;
b) a communication network connecting the smartphone device to the electronic assembly;
c) wherein the application software is configured to
i. display real-time data from the one or more gas sensors and the thermometer; display real-time video data from one or more cameras for remote monitoring;
ii. allow remote control of the fan, extractor, one or more speakers, light source, and electric door latch;
iii. set and modify threshold values for temperature and gas levels;
iv. send alerts to the smartphone device when threshold values are exceeded.

17. A noise-dampening dog kennel, consisting of:
a) a box-shaped housing having a plurality of walls, wherein the plurality of walls comprise layers of noise dampening acoustic insulated materials, a noise-dampening door mounted to the box-shaped housing by hinges, wherein said noise-dampening door comprises noise-dampening acoustic insulated materials; wherein said door has a transparent window on a central portion therein, wherein said hinges are demountable;
b) an electronic assembly including a power source, a controller, a fan, an extractor, one or more speakers and microphones, one or more cameras; wherein said one or more speakers include a first speaker placed on an outer surface of said box-shaped housing and a second speaker attached to a inner surface of said box-shaped housing, wherein said microphones include a first microphone attached to said outer surface of said box-shaped housing and a second microphone attached to said inner surface of said box-shaped housing, wherein said first speaker is configured to transmit sounds from inside of said box-shaped housing recorded by said second microphone, wherein said second speaker is configured to transmit sounds from outside of said box-shaped housing recorded by said first microphone, said electronic assembly further includes a light source mounted within the box-shaped housing, an oxygen meter, a carbon dioxide meter, a thermometer, and an electric door latch, wherein the controller activates the electric door latch in response to gas, temperature, or oxygen levels exceeding or falling below predefined thresholds, wherein said controller includes settings for adjusting lighting level of said light source, configuring ventilation settings, and filtering predetermined sounds obtained by said first microphone from outside of said box-shaped housing, wherein said second speaker is configured to produce white noise and music, said controller is configured to selectively actuate said one or more speaker and said microphones; and
c) a smartphone device running an application software; a communication network connecting the smartphone device to the electronic assembly; wherein the application software is configured to:
i. display real-time data from the one or more gas sensors and the thermometer; display real-time video data from the one or more cameras for remote monitoring;
ii. allow remote control of the fan, extractor, one or more speakers, light source, and electric door latch;
iii. set and modify threshold values for temperature and gas levels;
iv. send alerts to the smartphone device when threshold values are exceeded.
d) a ventilation assembly with noise-dampening baffles that permits the inflow of breathable air while dampening sound waves carried by the air when the door is closed, embedded within at least one wall of the plurality of walls, wherein said baffle box assembly includes a housing enclosing baffles and a base to support said baffles, said plurality of baffles arranged in an alternating pattern to define a switchback-shaped continuous channel for air to travel through, wherein each baffle extends partially across the width of the base, thereby defining an inlet portion and an outlet portion, wherein:
the inlet portion having the fan mounted at a distal end of a first hollow corridor, said fan is configured to introduce air inside the corridor formed by the baffles, the inlet portion having an air intake located at a distal end opposite to said fan, wherein said air intakes connects said first hollow corridor with an interior of said kennel; and
the outlet portion having the extractor mounted at a distal end of a second hollow corridor, said extractor is configured to extract air from the interior of the kennel, said outlet portion having a vent at a distal end opposite to said extractor.
